(19) United States
(12) Patent Application Publication
(10) Pub. No.: US 2006/0129408 A1
(43) Pub. Date: Jun. 15, 2006

(54) A REMOTE CONTROL DEVICE AND METHOD WITH SPEECH CONTROL

(76) Inventors: Jia-Lin Shen, Taipei County (TW); Yun-Wen Lee, Taipei City (TW); Yuan-Chia Lu, Hualien County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/162,567

(22) Filed: Sep. 15, 2005

(30) Foreign Application Priority Data
Dec. 14, 2004 (TW) 93138691

(51) Int. Cl. G10L 21/00

(52) U.S. Cl. 704/275

(57) ABSTRACT

A remote control device and method with speech control for controlling an electric appliance which stores up an identifiable speech vocabulary data. The remote control device includes a sensor and a speech identification module. The sensor receives speech to produce a speech sense signal. The speech identification module establishes contact to the electric appliance through communication protocol and obtains the identifiable speech vocabulary data with which a speech vocabulary of the speech sense signal is compared to produce a remote control signal. The remote control signal controls the said electric appliance by communication protocol.

### CROSS-REFERENCE TO RELATED APPLICATION

This application claims the priority benefit of Taiwan application serial no. 93138691, filed on Dec. 14, 2004. All disclosure of the Taiwan application is incorporated herein by reference.

### BACKGROUND OF THE INVENTION

1. Field of Invention

The present invention relates to a remote control device. More particularly, the present invention relates to a remote control device with speech control.

2. Description of Related Art

Language is a human native ability. Because everybody has the ability of speech, it is expected that various electric appliances for daily use or their remote controllers have the ability of speech control in order to simplify operations. Particularly, along with hand-held devices e.g. cell phone and PDA getting more and more popular, it is further expected that the existing hand-held devices can be used as the universal remote device for remotely controlling various electric appliances, so that it is not necessary to look for the special remote control device for controlling a certain electric appliance.

Refer to FIG. 1 which is the flow chart of a traditional remote control device. The remote control device 100 includes a number of buttons, a microprocessor 110 and a communication protocol module 112. Each button 105 can issue different signals according to the different settings of the microprocessor 110. Wherein, the remote control device 100 herein is a universal remote control device, so the action of synchronization should be done first in order to let the remote control device 100 know the order that the electric appliance 130 has and the communication protocol that both have. Therefore, in the process of synchronization, through the communication protocol module 112, the microprocessor 110 in the remote control device 100 uses the communication protocol of which both possess to obtain the available order data 135 from the electric appliance 130, and according to the available order data 135, each of the number of buttons 105 is set an order that it will issue.

After finishing the action of synchronization, the universal remote control device can be used as a general remote control device of the electric appliance 130. When a user presses a button 105, according to the button 105, the microprocessor 110 produces a corresponding order to the electric appliance 130. After receiving the order, the electric appliance 130 starts to execute the corresponding action of the order.

For using the traditional remote control device 100, a user has to find and take up the remote control device first, then seek a button on it and press the button. If the light is faint around, it will be very hard to find the remote control device or the button on it. Further more, when it is expected to add the function of the remote control device into the other devices e.g. a hand-held device, because of the difference between various hand-held devices, a great modification of the inner circuit in the hand-held devices will be necessary to fit the status, so it is not like plug and play with which it is very easy to add a new function.

### SUMMARY OF THE INVENTION

Accordingly, the present invention is directed to provide a remote control device with speech control for remotely controlling a number of electric appliances with speech and improving the adaptability of remote control devices to various electric appliances.

Besides, the present invention is to provide a remote control method with speech control for remotely controlling a number of electric appliances with speech and improving the adaptability of remote control devices to various electric appliances.

The present invention is to provide a remote control device with speech control for remotely controlling an electric appliance which stores up an identifiable speech vocabulary data. The remote control device includes a sensor and a speech identification module. The sensor receives a speech to produce a speech sense signal. Connecting with the sensor, the speech identification module establishes contact to the electric appliance through a special communication protocol and obtains the aforementioned identifiable speech vocabulary data, and according to the data, compares a speech vocabulary of the speech sense signal to produce a remote control signal. The remote control signal remotely controls the aforementioned electric appliance through the communication protocol.

According to a preferred embodiment of the present invention, the aforementioned remote control device with speech control further includes a communication protocol module. The aforementioned speech identification module uses the communication protocol module to establish contact to the aforementioned electric appliance through the aforementioned communication protocol, and the aforementioned remote control signal remotely controls the electric appliance through the communication protocol module.

According to the preferred embodiment of the present invention, the aforementioned remote control device with speech control further includes a display. The display receives and displays the aforementioned identifiable speech vocabulary data through the aforementioned communication protocol, and receives and displays the signal, which is transferred by the electric appliance and shows action status, through the aforementioned communication protocol. The aforementioned sensor is a microphone.

The present invention is to provide another remote control device with speech control for remotely controlling an electric appliance which stores up an identifiable speech vocabulary software. The remote control device includes a sensor and a microprocessor. The sensor receives a speech to produce a speech sense signal. Connecting with the sensor, the microprocessor obtains the identifiable speech vocabulary software in the aforementioned electric appliance through a communication protocol and executes the identifiable speech vocabulary software to identify and compare the aforementioned speech sense signal to produce a remote control signal. The remote control signal remotely controls the aforementioned electric appliance through the aforementioned communication protocol.

The present invention is further to provide a remote control device with speech control for remotely controlling electric appliance. The remote control device includes a sensor and a communication protocol module. The sensor receives a speech to produce a speech sense signal. Connecting with the sensor, the communication protocol module receives the aforementioned speech sense signal and produces a remote control signal through a communication protocol. The remote control signal remotely controls the aforementioned electric appliance through the communication protocol.

The present invention is further to provide a remote control method with speech control. First, an identifiable speech vocabulary data stored in an electric appliance is obtained through a communication protocol. Then, a speech is received, and the speech is identified and compared by means of the aforementioned identifiable speech vocabulary data. Last, the electric appliance is controlled by means of the communication protocol.

According to the remote control device with speech control of a preferred embodiment of the present invention, the steps of the aforementioned identification and comparison of speech and the remote control of the aforementioned electric appliance are: first, identifying the speech vocabulary of the speech; second, comparing the speech vocabulary with the aforementioned identifiable speech vocabulary data to produce a remote control signal; then, the aforementioned electric appliance receiving the remote control signal through the aforementioned communication protocol; last, the aforementioned electric appliance executing the action in accordance with the aforementioned remote control signal.

The present invention is to provide another remote control method with speech control. First, an identifiable speech vocabulary software stored in an electric appliance is obtained through a communication protocol. Then, a speech is received, and the aforementioned identifiable speech vocabulary software is executed to identify and compare the speech. Last, the electric appliance is controlled by means of the aforementioned communication protocol.

The present invention is further to provide a remote control method with speech control. First, a speech is received. Second, according to the speech, a speech signal is produced through a communication protocol. Then, the speech signal is transferred to an electric appliance through the aforementioned communication protocol. The electric appliance identifies and compares the aforementioned speech signal and executes the action in accordance with the aforementioned speech signal.

According to the calculation capability and the surplus memory capability of the remote control device, the present invention is determined to use one of the three modes of speech remote control, so that the adaptability of remote control devices to various electric appliances is great improved. Besides, because the mode controlling electric apparatus with speech remote control replaces the previous operations with buttons, the remote control interfaces become more humanization. Further more, the remote control devices with speech not only get rid of the problem that the lack of buttons in traditional technology makes some functions of electric apparatus unusable, but also enable more functions to be selected by speech.

In order to make the aforementioned and other objects, features and advantages of the present invention comprehensible, a preferred embodiment accompanied with figures is described in detail below.

### BRIEF DESCRIPTION OF THE DRAWINGS

FIG. 1 is the flow chart of the traditional remote control device.

FIG. 2 is the flow chart of the remote control device with speech control according to one of the preferred embodiments of the present invention.

FIG. 3 is the flow chart of the remote control device with speech control according to another preferred embodiment of the present invention.

FIG. 4 is the flow chart of the remote control device with speech control according to a further preferred embodiment of the present invention.

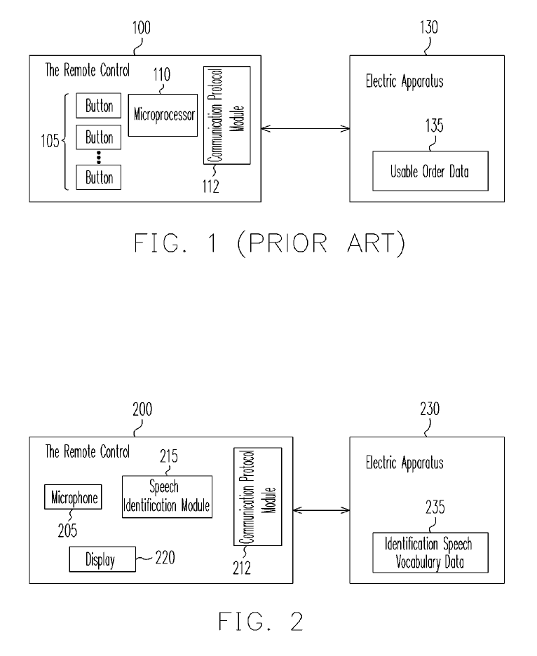

### DESCRIPTION OF EMBODIMENTS

The remote control device of the present invention identifies and compares orders in speech signals with a speech identification module or other modes to replace buttons on traditional selection remote control devices for outputting orders, so that the time for seeking a button place on a remote control can be saved and the operating interface is more humanized. Because the present invention places the function obtaining speech into a speech identification module, or uses a microprocessor to execute an identifiable speech vocabulary software, or even uses a remote control device only to receive speech other than identify speech, it is very easy to add these functions into other devices e.g. hand-held device and increase additional value of the devices.

Here a number of preferred embodiments are given to illustrate the present invention. FIG. 2 is the flow chart of the remote control device with speech control according to one of the preferred embodiments of the present invention. Referring to FIG. 2, the remote control device 200 includes a sensor 205, a speech identification module 215, a communication protocol module 212 and a display 220. Wherein, an electric apparatus 230 stores an identifiable speech vocabulary data 235 which is the speech vocabulary that the electric apparatus 230 can identify. Further more, according to the speech vocabulary, the electric apparatus 230 can perform the corresponding actions, for example, controlling the sound volume of a video device and the wind speed of an electric fan.

Wherein, the remote control device 200 can be used to control various kind of electric products. Before being used, the remote control device 200 needs to perform the synchronization with the electric apparatus 230 to transfer messages and needed information between them by means of the common communication protocol. Traditional infrared (IR) transmission, radio frequency (RF) transmission and Bluetooth are the communication protocols in common use.

In this embodiment the sensor 205 is a microphone used to receive the speech of a user and convert the speech into the speech sense signals so as to be identified by the speech identification module 215. The speech identification module 215 receives the above speech sense signals and identifies and compares the speech vocabulary in the speech signals.

Because the speech vocabularies that each electric apparatus can identify are not same and the correspondences between the identifiable speech vocabularies and the orders are either not identical, when synchronization, the identifiable speech vocabulary data 235 in the electric apparatus 230 should be transferred into the remote control device 200 first, so that the speech identification module can identify and compare the speech sense signals by means of this identifiable speech vocabulary data 235 to produce remote control signals acceptable for the electric apparatus 230.

The communication protocol module 212 receives the aforementioned remote control signal and transfers the remote control signal to the electric apparatus 230 by means of the communication protocol with which the communication protocol module 212 can communicate with the electric apparatus 230. The electric apparatus 230 receives the remote control signal and performs the corresponding action according to the signal so as to reach the goal of the remote control.

The display 220 in the remote control device 200 enables a user to look up the functions of some particular speech vocabulary by means of the transferred identifiable speech vocabulary data 235, or enables the user to see the current operation status of the electric apparatus 230 after the electric apparatus 230 receives the remote control signal and sends back a signal showing the action status to the display 220.

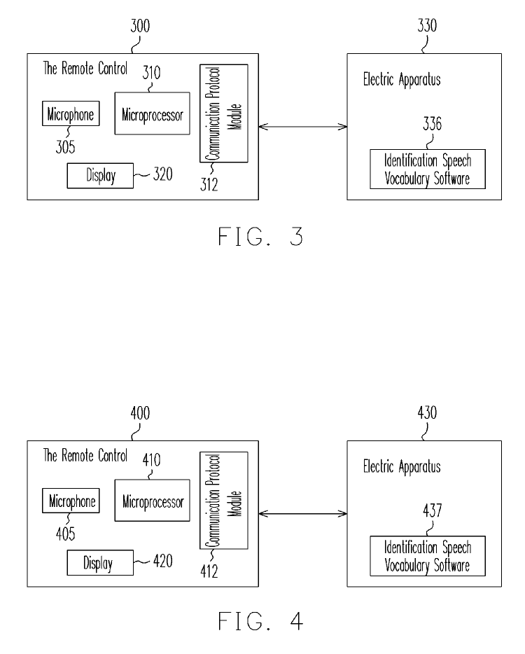

Here another preferred embodiment is given to illustrate the present invention. Refer to FIG. 3 which is the flow chart of the remote control device with speech control according to another preferred embodiment of the present invention. Wherein, a sensor 305, a communication protocol module 312 and a display 320 are same with the sensor 205, the communication protocol module 212 and the display 220 in the previous embodiment, so is it not necessary to say again.

The difference of this embodiment from the previous one is that the remote control device 300 does not have a speech identification module, so that it can not identify the speech sense signal that the sensor 305 produces. Therefore, during the synchronization, the remote control device 300 has to transfer the identifiable speech vocabulary software 336, which includes the identifiable speech vocabulary data, from the electric apparatus 330 to the microprocessor 310 in the remote control device 300 by means of the communication protocol.

Executing the identifiable speech vocabulary software 336, the microprocessor 310 identifies the speech vocabulary in the speech sense signal and, through identifying and comparing, obtains the speech vocabulary grammar signal which is identifiable for the electric apparatus 330. Then the signal is transferred to the electric apparatus 330 by means of the communication protocol module 312. The operation principle of the rest is same with that of the previous embodiment.

Here a further preferred embodiment is given to illustrate the present invention. FIG. 4 is the flow chart of the remote control device with speech control according to a further preferred embodiment of the present invention. Referring to FIG. 4, wherein, a sensor 405, a communication protocol module 412 and a display 420 are same with the sensor 205/305, the communication protocol module 212/312 and the display 220/320 in the previous two embodiments, so is it not necessary to say again.

The difference of this embodiment from the previous two is that the capability of calculation of the microprocessor 410 in the remote control device 400 is too low to perform the speech identification and comparison, or the capability of the memory of the microprocessor 410 is too low to receive all the identifiable speech vocabulary module. Compared with FIG. 3, only the identifiable speech vocabulary data out of the identifiable speech vocabulary software 437 is transferred to the microprocessor 410. This is to let the user know the recognizable vocabulary data for the electric appliance. The microprocessor 410 can only transform the speech sense signal received by the microphone 405 into the speech signal and output the speech signal to the electric apparatus 430 through the communication protocol module 412. That is not like the previous two embodiments which have the speech identification module 215 or whose microprocessor 310 can receive the identifiable speech vocabulary software 336 and execute it.

Accordingly, instead of performing the actions e.g. identification and comparison in the remote control device 400, the microprocessor 410 here only needs to transfer the received speech sense signal to the electric apparatus 430 through the communication protocol module 412. Namely, the remote control device 400 here only receives speech and other calculations are dealt with by the speech identification vocabulary module 437 in the electric apparatus 430. When the synchronization is performed, only the identifiable speech vocabulary needs to show on the display 420 for the user to know the speech vocabulary. This mode particularly fits the remote control device 400 with a low capability of calculation.

The aforementioned three embodiments can be differentiated by means of detecting the calculation capability and the surplus memory capability of the microprocessor in the remote control device. Therefore, when using the remote control device, a user can preset one of the modes, or uses the apparatus to detect the best mode automatically, or freely selects one of the aforementioned three modes, so as to get the best effect of the remote control of the electric apparatus.

In summary, according to the calculation capability and the surplus memory capability of remote control devices, the present invention can be determined to use one of three modes of the speech remote control, so that the adaptability of remote control devices to various electric appliances is great improved. Besides, because the mode controlling electric apparatus with speech remote control replaces the previous operations with buttons, the remote control interfaces become more humanization. Further more, the remote control devices with speech not only get rid of the problem that the lack of buttons in traditional technology makes some functions of electric apparatus unusable, but also enable more functions to be selected by speech.

The present invention is disclosed above with its preferred embodiments. It is to be understood that the preferred embodiment of present invention is not to be taken in a limiting sense. It will be apparent to those skilled in the art that various modifications and variations can be made to the structure of the present invention without departing from the scope or spirit of the invention. The protection scope of the present invention is in accordance with the scope of the following claims and their equivalents.

What is claimed is:

1. A remote control device with speech control for remotely controlling an electric appliance which stores up an identifiable speech vocabulary data comprises:
a sensor used to receive a speech in order to produce a speech sense signal; and
a speech identification module coupling to the sensor and establishing contact to the electric appliance through a communication protocol to obtain the identifiable speech vocabulary data which is used to compare with a speech vocabulary of the speech sense signal so as to produce a remote control signal which remotely controls the electric appliance through the communication protocol.

2. The remote control device with speech control as claimed in claim 1, wherein, further comprises a communication protocol module which is used by the speech identification module to establish contact to the electric appliance through the communication protocol, and that the speech signal remotely controls the electric appliance by means of the communication protocol module.

3. The remote control device with speech control as claimed in claim 1, wherein, further comprises a display which, through the communication protocol, receives and displays the identifiable speech vocabulary data and a signal which is transferred by the electric appliance and shows action status.

4. The remote control device with speech control as claimed in claim 1, wherein, the sensor is a microphone.

5. A remote control device with speech control for remotely controlling an electric appliance which stores up an identifiable speech vocabulary software, comprises:
a sensor used to receive a speech in order to produce a speech sense signal; and
a microprocessor, coupling to the sensor, obtains an identifiable speech vocabulary software in the electric appliance through a communication protocol, and executes the identifiable speech vocabulary software to identify and compare the speech sense signal to produce a remote control signal which remotely controls the electric appliance through the communication protocol.

6. The remote control device with speech control as claimed in claim 5, wherein, further comprises a communication protocol module which is used by the microprocessor to establish contact to the electric appliance through the communication protocol, and that the speech signal remotely controls the electric appliance by means of the communication protocol module.

7. The remote control device with speech control as claimed in claim 5, wherein, the identifiable speech vocabulary software, which is stored in the electric appliance, comprises an identifiable speech vocabulary data to be used to compare a speech vocabulary in the speech sense signal to produce a remote control signal.

8. The remote control device with speech control as claimed in claim 5, wherein, further comprises a display which, through the communication protocol, receives and displays the identifiable speech vocabulary data and a signal which is transferred by the electric appliance and shows action status.

9. The remote control device with speech control as claimed in claim 5, wherein, the sensor is a microphone.

10. A remote control device with speech control for remotely controlling an electric appliance which stores up an identifiable speech vocabulary software, comprises:
a sensor used to receive a speech in order to produce a speech sense signal; and
a communication protocol module, coupling to the sensor, is used to receive the speech sense signal, and through the communication protocol to produce a speech signal which remotely controls the electric appliance through the communication protocol.

11. The remote control device with speech control as claimed in claim 10, wherein, further comprises a display which, through the communication protocol, receives and displays a signal which is transferred by the electric appliance and shows action status.

12. The remote control device with speech control as claimed in claim 10, wherein, the sensor is a microphone.

13. A remote control method with speech control comprises:
obtaining an identifiable speech vocabulary data stored in an electric appliance by means of a communication protocol;
receiving a speech;
identifying and comparing the speech according to the identifiable speech vocabulary data; and
controlling the electric appliance by means of the communication protocol.

14. The remote control method with speech control as claimed in claim 13, wherein, the steps of identifying and comparing the speech comprise:
identifying a speech vocabulary in the speech; and
comparing the speech vocabulary according to the identifiable speech vocabulary data to produce a remote control signal.

15. The remote control method with speech control as claimed in claim 14, wherein, the steps of remotely controlling the electric apparatus comprise:
the electric appliance receiving the remote control signal through the communication protocol; and
the electric appliance performing an action in accordance with the remote control signal.

16. A remote control method with speech control comprises:
obtaining an identifiable speech vocabulary software stored in an electric appliance through a communication protocol;
receiving a speech;
identifying and comparing the speech by means of executing the identifiable speech vocabulary software; and
controlling the electric appliance by means of the communication protocol.

17. The remote control method with speech control as claimed in claim 16, wherein, the steps of identifying and comparing the speech comprise:
identifying a speech vocabulary in the speech; and
comparing the speech vocabulary by means of an identifiable speech vocabulary data in the identifiable speech vocabulary software to produce a remote control signal.

18. The remote control method with speech control as claimed in claim 17, wherein, the steps of remotely controlling the electric apparatus comprise:
the electric appliance receiving the remote control signal through the communication protocol; and
the electric appliance performing an action in accordance with the remote control signal.

19. A remote control method with speech control comprises:
receiving a speech;
producing a speech signal by means of a communication protocol;
transferring the speech signal to the electric appliance through the communication protocol;
the electric appliance identifying and comparing the speech signal; and
the electric appliance performing an action in accordance with the speech signal.
